(19) United States
(12) Patent Application Publication
(10) Pub. No.: US 2026/0313041 A1
(43) Pub. Date: Oct. 8, 2026

(54) CUSTOM DATA RESOURCE GENERATION FOR PROVISIONING DESIRED COMPUTER IMPLEMENTED SERVICES

(71) Applicant: Dell Products L.P., Round Rock, TX (US)

(72) Inventors: XIAOCHEN CHEN, Shanghai (CN); ZIJIA WANG, London (GB); NING LI, Shanghai (CN); RUI CHEN, Shanghai (CN)

(21) Appl. No.: 19/098,867

(22) Filed: Apr. 2, 2025

(51) Int. Cl. H04L 67/60; H04L 67/00

(52) U.S. Cl. CPC H04L 67/60; H04L 67/34

(57) ABSTRACT

Methods and systems for providing desired computer implemented services using data stored in data sources of a distributed system are disclosed. The desired computer implemented services may be provided by generating a custom data resource. The custom data resource may be generated by obtaining first identifiers of local data tables and/or third identifiers of new local data tables. The third identifiers may include second identifiers of remote data tables. The custom data resource may be further generated by performing an update process on dependencies of the first identifiers and/or the third identifiers. The custom data resource may be used by information extraction frameworks to extract information from the custom data resource. The information may be used to facilitate provisioning of the desired computer implemented services.

### FIELD

Embodiments disclosed herein relate generally to providing desired computer implemented services using data stored in data sources of a distributed system. More particularly, embodiments disclosed herein relate to generating a custom data resource for provisioning of the desired computer implemented services.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2B show data flow diagrams illustrating operation of a distributed system in accordance with an embodiment.

FIG. 3 shows a flow diagram illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to providing desired computer implemented services using data stored in data sources of a distributed system. The desired computer implemented services may be provided by generating a custom data resource using the data for provisioning of the desired computer implemented services.

The custom data resource may be generated by (i) obtaining first identifiers of local data tables from a local portion of the distributed system, (ii) obtaining second identifiers of remote data tables from a remote portion of the distributed system, the first identifiers including first dependencies on the second identifiers and/or the second identifiers including second dependencies on the first identifiers, (iii) using the second identifiers to generate third identifiers of new local data tables, the third identifiers being references to the second identifiers, and/or (iv) using the first identifiers and/or the third identifiers to obtain the custom data resource.

The custom data resource may be obtained by (i) identifying dependencies between the first identifiers and/or the third identifiers (e.g., the references to the second identifiers), (ii) identifying, using at least the dependencies, an update process to update the first identifiers and/or the third identifiers, and/or (iii) performing the update process to update the data included in the custom data resource.

A processable query may be ingested by information extraction frameworks for extraction of information from the distributed system. The custom data resource may be used by the information extraction frameworks to extract the information. The information may be used to facilitate the provisioning of the desired computer implemented services.

In an embodiment, a method for providing desired computer implemented services using data stored in data sources of a distributed system is disclosed. The method may include: (i) obtaining a query that implicates a custom data resource of data resources, the custom data resource being based only on local portions of the data of the data resources, (ii) obtaining an update process for the custom data resource, (iii) performing the update process to update at least one value of the custom data resource to generate an updated value of the custom data resource, the update process defining an ordering for updating of the local portions of the data and remote portions of the data of the data resources upon which the local portions of the data are based, the ordering being based on dependencies between the custom data resource, the local portions of the data, and the remote portions of the data, (iv) using the updated value to generate a response to the query, and (v) servicing the query using the response to facilitate provisioning of the desired computer implemented services.

At least a sub-portion of the local portions of the data may include copies of the remote portions of the data.

The distributed system may include a plurality of clusters, and each of the plurality of the clusters may host a respective portion of the data sources.

The custom data resource may be hosted by one of the plurality of the clusters, and the remote portions of the data may be hosted by other clusters of the plurality of the clusters that are not the one of the plurality of the clusters.

The local portions of the data may be hosted by the one of the plurality of the clusters.

The query may specify at least one operation to be performed with respect to the custom data resource.

The at least one operation may be with respect to the updated value.

The custom data resource may be based on a user request for the custom data resource.

The custom data resource may be derived from the data, and the data being a system of record for an organization.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

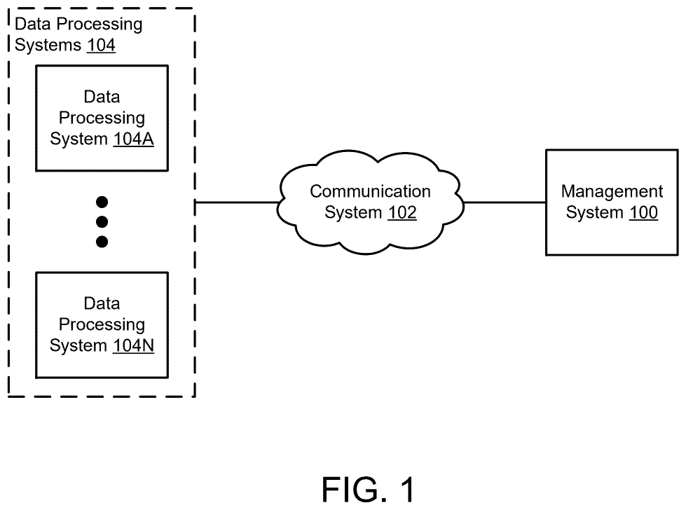

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a query may be processed for the extraction of data from a distributed system. The distributed system may include a plurality of clusters. A local portion of the distributed system may include a first portion of the plurality of the clusters and/or a remote portion of the distributed system may include a second portion of the plurality of the clusters.

The query may be processed by generating, by the distributed system, sub-queries of the query. A first sub-query of the sub-queries may be transmitted to the local portion of the distributed system and/or a second sub-query of the sub-queries may be transmitted to the remote portion of the distributed system. The first sub-query and/or the second sub-query may be processed by information extraction frameworks of the distributed system to extract the data. The information extraction frameworks may include query execution engines compatible with at least the query, the sub-queries (e.g., the first sub-query, the second sub-query, etc.).

However, the data that has been extracted may be (i) obsolete, (ii) not up-to-date, and/or (iii) unreliable due to (i) delays in data collection by the remote portion of the distributed system, (ii) latency in transmission of the data to the remote portion, (iii) ineffective protocols for updating and/or managing the data, (iv) outdated storage systems that do not support timely updates to the data, and/or (v) any other cause affecting and/or inefficiency by at least one component and/or process of the remote portion of the distributed system.

In general, embodiments disclosed here relate to systems and methods for providing desired computer implemented services using data stored in data sources of a distributed system. The desired computer implemented services may be provided by (i) obtaining a query that implicates a custom data resource of data resources, the custom data resource being based only on local portions of the data of the data resources, (ii) obtaining an update process for the custom data resource, (iii) performing the update process to update at least one value of the custom data resource to generate an updated value of the custom data resource, the update process defining an ordering for updating of the local portions of the data and remote portions of the data of the data resources upon which the local portions of the data are based, the ordering being based on dependencies between the custom data resource, the local portions of the data, and the remote portions of the data, (iv) using the updated value to generate a response to the query, and/or (v) servicing the query using the response to facilitate provisioning of desired computer implemented services.

The query may be obtained by receiving, by the distributed system, the query. The query may implicate a custom data resource by attempting, by the information extraction frameworks, to service the query using the custom data resource. To perform an attempt to service the query, the custom data resource may first be derived by the distributed system. The custom data resource may be derived from the data, the data being from a system of record (i.e., the data sources) of the distributed system and/or used to generate a custom data resource.

The update process may be obtained, once the custom data resource has been derived, by determining the ordering for the updating. The ordering may be based on dependencies between the custom data resource, the local portions of the data, and the remote portions of the data. The ordering may be determined by performing at least one trace of first data that is dependent on second data. Determination of the ordering may include (i) an iterative process, (ii) a batch process, (iii) an extraction and/or loading process, etc. to map the dependencies.

The update process may be performed by performing at least one update using the ordering. The performance of the at least one update may include, for example, (i) performing a first update to the second data and/or (ii) performing a second update to the first data, which includes the dependency on the second data. By performing the at least one update, the updated value, which includes dependencies on at least the first data and/or the second data, may be generated.

The updated value may be used to generate a response. The updated value may be used by (i) extracting, by the distributed system, the updated value and/or (ii) including, by the distributed system, the updated value in the response to the query.

The query may be serviced by performing, by the information extraction frameworks, an extraction of information, the information being based on at least the updated value of the custom data resource. The information may be used to facilitate a provisioning of desired computer implemented services. The provisioning may include (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

To provide the above noted functionality, the system may include a management system (e.g., 100), and data processing systems (e.g., 104). Each of these components is discussed below.

The data processing systems (e.g., 104) may include any number at least one data processing system (e.g., 104A-104N). The any number of at least one data processing system (e.g., 104A-104N) may host an entity. The entity may include (i) a user, (ii) an administrator, and/or (iii) any other stakeholder of the distributed system. The entity may generate a request for information which with to provision desired computer implemented services. The request may be received by the any number of data processing systems (e.g., 104A-104N).

To service the request, the management system (e.g., 100) and/or the any number at least one data processing system (e.g., 104A-104N) may generate a custom data resource. The custom data resource may be derived from the data, the data being from a system of record (i.e., the data sources) of the distributed system and/or used to generate data resources.

The distributed system may include a plurality of clusters (e.g. the any number of data processing systems (e.g., other sets of 104A-104N)) as clusters. A local portion of the distributed system may include a first portion of the plurality of the clusters and/or a remote portion of the distributed system may include a second portion of the plurality of the clusters. The data sources may be hosted on the first portion and/or the second portion.

The data resources may be used to generate the custom data resource on the local portion of the distributed system. The data resources may include at least one dependency between local portions of the data and/or remote portions of the data of the data resources. The custom data resource may include a first sub-portion of the local portions of the data and a second sub-portion of the remote portions, the second sub-portion including references of the remote portions of the data.

The custom data resource may include at least one dependency between the first sub-portion and/or the second sub-portion. For example, first data of the first sub-portion may depend on a second data of the second sub-portion. Thus, to update the custom data resource, an ordering for updating may be determined. An updating may be performed thus, using the ordering, by the management system (e.g. 100) and/or the any number at least one data processing system (e.g., 104A-104N).

The management system (e.g., 100) and/or the any number at least one data processing system (e.g., 104A-104N) may receive a query for an extraction of information from the distributed system. The management system (e.g., 100) and/or the any number at least one data processing system (e.g., 104A-104N) may include information extraction frameworks by which to service the query. The information extraction frameworks may include query execution engines compatible with the query. To service the query, the information extraction frameworks may obtain the information using the custom data resource. The information may be used for provisioning of desired computer implemented services by the distributed system.

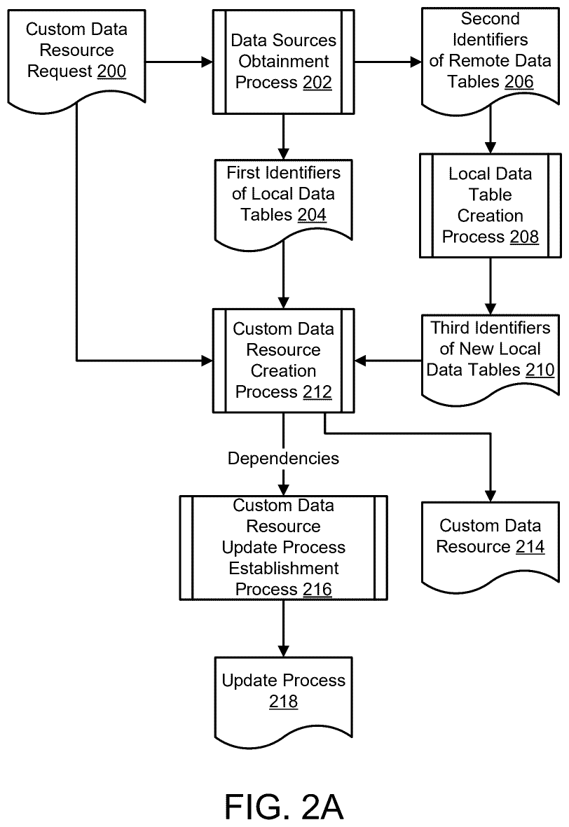

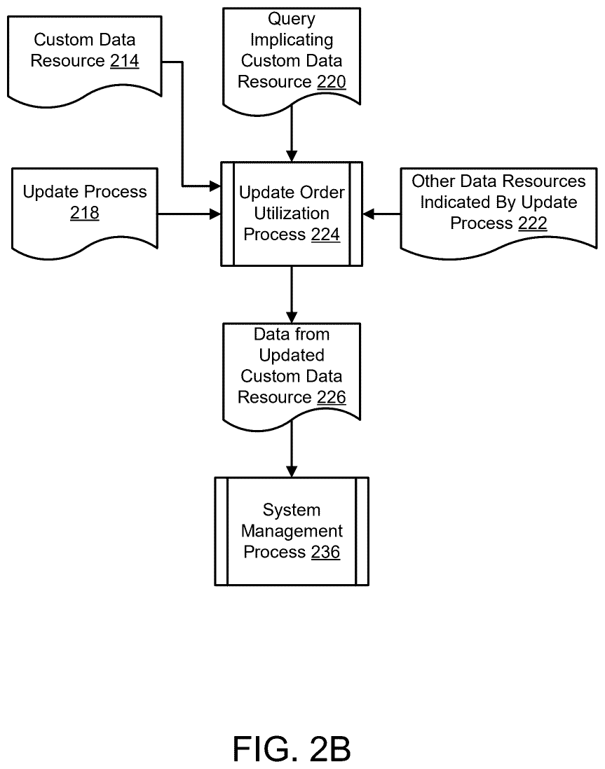

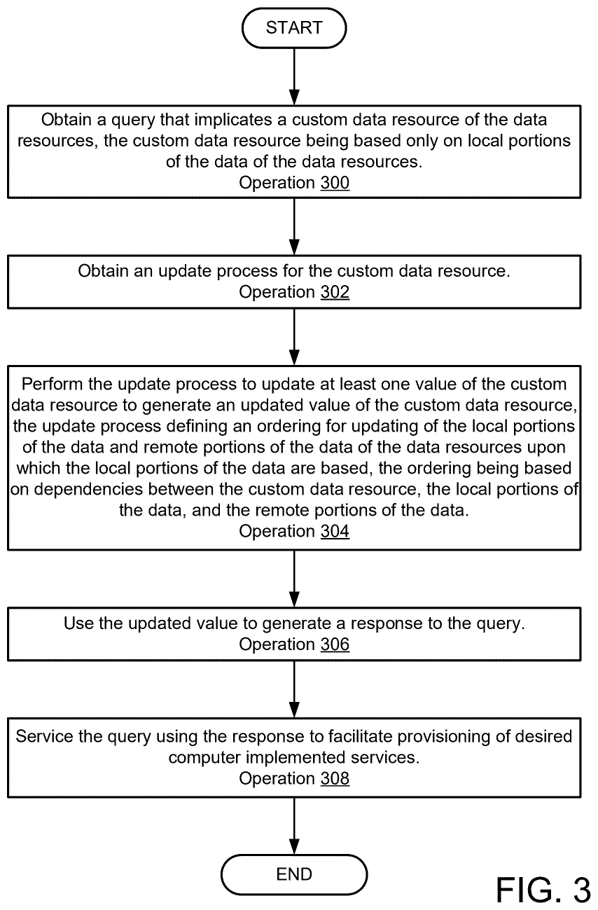

While providing their functionality, any of the management system (e.g., 100) and the data processing systems (e.g., 104) may perform all, or a portion, of the flows and methods shown in FIGS. 2A-3.

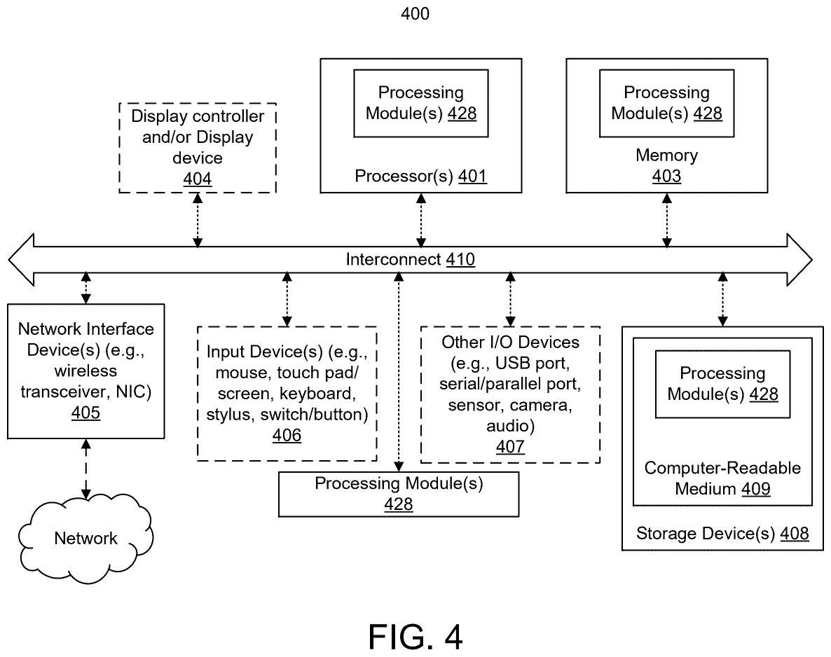

Any of (and/or components thereof) the management system (e.g., 100) and the data processing systems (e.g., 104) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with a communication system (e.g., 102). In an embodiment, the communication system (e.g., 102) includes one or more networks that facilitate communication between any number of components. The networks may include wired networks and/or wireless networks (e.g., and/or the Internet). The networks may operate in accordance with any number and types of communication protocols (e.g., such as the Internet protocol).

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 200, 204, etc.) is used to represent data structures and a second set of shapes (e.g., 202, 208, etc.) is used to represent processes performed using and/or that generate data.

Turning to FIG. 2A, a first data flow diagram in accordance with an embodiment is shown. The first data flow diagram may illustrate data used in and data processing performed in generating a custom data resource (e.g., 214) and/or an update process (e.g., 218).

To generate the custom data resource (e.g., 214) and/or the update process (e.g., 218), a data sources obtainment process (e.g., 202) may be performed. During the data sources obtainment process (e.g., 202), a custom data resource request (e.g., 200) may be obtained.

The custom data resource request (e.g., 200) may be obtained through servicing of a processable query by information extraction frameworks. The processable query may include statements and/or clauses with at least one instruction to be performed by the information extraction frameworks. The statements and/or the clauses may include data source identifiers to identify data of data sources. The data sources may include a system of record of the distributed system. The data sources may be stored on a first local portion of the distributed system and/or a second remote portion of the distributed system. The data sources may include (i) data tables, (ii) data matrices, (iii) data grids, and/or (iv) any other data structures that include the data and/or that are stored on the first local portion and/or the second remote portion.

During the data sources obtainment process (e.g., 202), first identifiers of local data tables (e.g., 204) and/or second identifiers of remote data tables (e.g., 206) may be obtained.

The first identifiers (e.g., 204) and/or the second identifiers (e.g., 206) may be obtained by (i) servicing, by the information extraction frameworks, at least one of the statements and/or at least one of the clauses of the processable query that performs a request for the first identifiers (e.g., 204) and/or the second identifiers (e.g., 206), (ii) performing an application programming interface (API) call for the first identifiers (e.g., 204) and/or the second identifiers (e.g., 206), etc. To performing the request, the API call, etc., the information extraction frameworks and/or the API may include a first connection to the first local portion and/or a second connection to the second remote portion of the distributed system. A customized syntax may be included in the at least one statement, in the at least one of the clauses, in the API call, etc. The customized syntax may include, for example, a user-defined call for initiating generation of a custom data resource.

The first identifiers (e.g., 204) and/or the second identifiers (e.g., 206) may include (i) data table names, (ii) schema names (e.g., first names based on an organization of the data table), (iii) database names (e.g., second names based on (a) data table names, (b) data matrix names, (c) data grid names, and/or (d) the any other data structure names), (iv) primary keys (e.g., unique identifiers for rows within the data table), (v) metadata, (vi) numbers (e.g., (a) integers, (b) floats, (c) decimals, and/or (d) any other type of number), etc.

Using the second identifiers of the remote data tables (e.g., 206), a local data table creation process (e.g., 208) may be performed. During the local data table creation process (e.g., 208), (i) mapped remote identifiers may be generated using the second identifiers of the remote data tables (e.g., 206) and/or (ii) third identifiers of new local data tables (e.g., 210) may be generated from the mapped remote identifiers.

The mapped remote identifiers may include, for example, string identifiers, the string identifiers including at least a base name and/or a suffix. The base name may include a first string which includes a second identifier of the second identifiers of the remote data tables (e.g., 206). The suffix may include a second string that includes an identification of the second remote portion of the distributed system in which the second identifiers of the remote data tables (e.g., 206) are stored.

The third identifiers of new local data tables (e.g., 210) may be generated by (i) generating a local data table with a number of dimensions (e.g., (a) rows, (b) columns, and/or (c) any other dimension), and/or (ii) populating the local data table with the mapped remote identifiers.

The third identifiers of the new local data tables (e.g., 210) may include the local data table with at least one reference (e.g., a mapped identifier of the mapped remote identifiers based on the second identifiers of the remote data tables (e.g., 206)) to the remote data tables of the second remote portion of the distributed system. The at least one reference may identify (i) the data table names, (ii) the schema names, (iii) database names, (iv) the primary keys, (v) the metadata, (vi) the numbers, etc.

Using the first identifiers of the local data tables (e.g., 204) and/or the third identifiers of the new local data tables (e.g., 210), a custom data resource creation process (e.g., 212) may be performed. During the custom data resource creation process (e.g., 212), a custom data resource (e.g., 214) may be generated.

The custom data resource (e.g., 214) may be generated by identifying dependencies between the first identifiers of the local data tables (e.g., 204) and/or the third identifiers of the new local data tables (e.g., 210). The dependencies may indicate at least one relationship between the local data tables and/or the new local data tables. The dependencies may be identified using (i) foreign keys of the local data tables and/or of the new local data tables, (ii) metadata to identify the at least one relationship between first data of a local data table and/or second data of the new local data table, (iii) data lineage tools to track a flow of at least the first data and/or the second data, the flow indicating how the first data and/or the second data are transformed and/or are related, (iv) a manual analysis by an entity (e.g., (a) a user, (b) an administrator, and/or (c) any other stakeholder of the distributed system) of the at least one relationship between the first data and/or the second data, (v) any other component of the local data tables and/or the new local data tables, and/or (vi) any other tool, process and/or analysis to identify the dependencies.

The custom data resource (e.g., 214) may include a data set of the local data tables and/or the new local data tables. The custom data resource (e.g., 214) may further include a data schema for the local data tables and/or the new local data tables. The data schema may include at least one definition of a second organization, including the dependencies, of the local data tables and/or the new local data tables. The custom data resource (e.g., 214) may be stored in a local repository on the first local portion of the distributed system.

Using the custom data resource (e.g., 214), a custom data resource update process establishment process (e.g., 216) may be performed. During the custom data resource update process establishment process (e.g., 216), an update process (e.g., 218) for the custom data resource (e.g., 214) may be derived. To define the update process (e.g., 218), the first data may be updated and/or the second data, on which the first data depends, may be updated. However, based on unique relationships between the local data tables and/or the new local data tables, a first update of the first data and/or the second update of the second data may depend on the data schema for the custom data resource (e.g., 214). Depending on the structure of the dependencies, as defined by the data schema, derivation of the update process (e.g., 218) may include (i) an iterative process, (ii) a batch process, (iii) an extraction and/or loading process, etc.

The update process (e.g., 218) may include an ordering of updates of the data of the custom data resource (e.g., 214). For example, the update process (e.g., 218) may define a list of first data, second data, third data towards a last data. Using the list, the first data may be updated, followed by the second data being updated, then the third data being updated towards the last data being updated. By defining the update process (e.g., 218) in the ordering, the first identifiers of the local data tables (e.g., 204) and/or the third identifiers of the new local data tables (e.g., 210) may be (i) up-to-date, (ii) not obsolete, and/or (iii) applicable for desired computer implemented services.

Thus, via the first data flow illustrated in FIG. 2A, a system in accordance with an embodiment may generate the custom data resource (e.g., 214) and/or the update process (e.g., 218). Consequently, a distributed system may be more likely to be able to provide desired computer implemented services by generating a centralized data set of identifiers and/or an ordering for updating the identifiers.

Turning to FIG. 2B, a second data flow diagram in accordance with an embodiment is shown. The second data flow diagram may illustrate data used in and data processing performed in performing a system management process (e.g., 236).

To perform the system management process (e.g., 236), an update order utilization process (e.g., 224) may be performed. During the update order utilization process (e.g., 224), a custom data resource (e.g., 214), an update process (e.g., 218), a query implicating the custom data resource (e.g., 220), and/or other data resources (e.g., 222) indicated by the update process may be used to update data from the custom data resource (e.g., 226).

The custom data resource (e.g., 214) and the update process (e.g., 218) are described in the description of FIG. 2A. The query implicating the custom data resource (e.g., 220) is described in the description of FIG. 2A as well. The query implicating the custom data resource (e.g., 220) may include a processable query. The query may be processable by information extraction frameworks. The query may include statements and/or clauses with at least one instruction to be performed by information extraction frameworks.

The other data resources (e.g., 222) indicated by the update process (e.g., 218) may include (i) other data repositories, (ii) application programming interfaces (APIs), (iii) web scraping tools, (iv) real-time data streams, (v) trained machine learning models, etc. from which the query (e.g., 220) extracts ingestible data that is not included in the custom data resource (e.g., 214).

During the update order utilization process (e.g., 224), an ordering of the update process (e.g., 218) may be used to update a first data, then a second data, then a third data, towards a last data. The first data may include (i) no dependencies in the custom data resource (e.g., 214) and/or (ii) at least one first dependency of the ingestible data from the other data resources (e.g., 222). The second data may include (i) at least one second dependency on the first data, and/or (ii) at least one third dependency on the ingestible data from the other data resources (e.g., 222). The third data may include (i) at least one fourth dependency on the second data, (ii) at least one fifth dependency on the first data, and/or (iii) at one sixth dependency on the ingestible data from the other data resources (e.g., 222). The last data may include (i) at least one seventh dependency on any data (e.g., (i) the first data, (ii) the second data, (iii) the third data, (iv) the ingestible data, and/or (v) any other data) of the custom data resource (e.g., 214). In addition, (i) an iterative process, (ii) a batch process, (iii) an extraction and/or loading process, and/or (iv) any other process may be performed to use the dependencies to update the data of the custom data resource (e.g., 214). As a result, the data from an updated custom data resource (e.g., 226) may be generated.

The data from an updated custom data resource (e.g., 226) may include updated data of the custom data resource (e.g., 214), the updated data being generated during the update order utilization process (e.g., 224). The data may include references (i) updated data table names, (ii) updated schema names (e.g., first names based on an organization of the data table), (iii) updated database names (e.g., second names based on (a) data table names, (b) data matrix names, (c) data grid names, and/or (d) the any other data structure names), (iv) updated primary keys (e.g., unique identifiers for row within the data table), (v) updated metadata, (vi) updated numbers (e.g., (a) updated integers, (b) updated floats, (c) updated decimals, and/or (d) any other type of updated number), etc.

Using the data from an updated custom data resource (e.g., 226), the system management process (e.g., 236) may be performed. During the system management process (e.g., 236), the query (e.g., 220) may be serviced by the information extraction frameworks and/or using the custom data resource (e.g., 214). During the servicing of the query (e.g., 220), the statements and/or the clauses of the query may be extracted. Based on an instruction of each of the statements and/or each of the clauses, information, based on the data (e.g., 226), may be identified and/or extracted by the information extraction frameworks.

The information may be used to facilitate provisioning at least the portion of the desired computer implemented services by (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

Thus, via the second data flow illustrated in FIG. 2B, a system in accordance with an embodiment may perform the system management process (e.g., 236). Consequently, a distributed system may be more likely to be able to provide desired computer implemented services by extracting, by the information extraction frameworks, information based on the data from the updated custom data resource (e.g., 226).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to provide desired computer implemented services using data stored in data sources of a distributed system. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of providing desired computer implemented services using data stored in data sources of a distributed system in accordance with an embodiment is shown. The method may be performed, for example, by any of the components of the system of FIG. 1, and/or other components not shown therein.

At operation 300, a query may be obtained that implicates a custom data resource of the data resources, the custom data resource being based only on local portions of the data of the data resources. The query may be obtained by receiving, by the distributed system and/or from (i) a user, (ii) an administrator, (iii) a data processing system, and/or (iv) any other stakeholder of the distributed system, the query.

At operation 302, an update process may be obtained for the custom data resource. The update process may be obtained by (i) identifying dependencies between data of the custom data resource and/or (ii) identifying, using the dependencies, an ordering by which at least a first data and/or a second data, which depends on the first data, is updated. The first data and/or the second data may be included in the custom data resource.

At operation 304, the update process may be performed to update at least one value of the custom data resource to generate an updated value of the custom data resource, the update process defining an ordering for updating of the local portions of the data and remote portions of the data of the data resources upon which the local portions of the data are based, the ordering being based on dependencies between the custom data resource, the local portions of the data, and the remote portions of the data. The update process may be performed by (i) performing a first update to the first data, (ii) performing a second update to the second data, which depends on the first data, and/or performing further updates to generate the updated value. The update process may include (i) an iterative process, (ii) a batch process, (iii) an extraction and/or loading process, etc.

At operation 306, the update value may be used to generate a response to the query. The updated value may be used by (i) extracting, by the distributed system, the updated value and/or (ii) including, by the distributed system, the updated value in the response to the query.

At operation 308, the query may be serviced using the response to facilitate provisioning of desired computer implemented services. The query may be serviced by performing, by the information extraction frameworks, an extraction of information, the information being based on at least the updated value of the custom data resource. The other data may be used to facilitate a provisioning of desired computer implemented services. The provisioning may include (i) facilitating performance of optimization actions based on, for example, performance metrics, (ii) adding security patches and/or configurations based on vulnerabilities and/or threat patterns, (iii) adding, modifying, and/or removing access rights based on roles and/or historical usage, (iv) facilitating the performance of incident response actions based on historical incident data and/or a current system status, and/or (v) facilitating the performance, addition, modification, removal, monitoring, securing, etc. of any process, data, software, hardware, etc. to any portion of the distributed system.

The method may end following operation 308.

Thus, via the method shown in FIG. 3, embodiments herein may likely improve a likelihood of providing the desired computer implemented services using the data stored in the data sources of the distributed system. By improving the likelihood of providing the desired computer implemented services using the data stored in the data sources of the distributed system, the distributed system may be more likely to provide desirable computer implemented services by, for example, generating a custom data resource based on at least references to the data on the remote portions of the distributed system, updating the custom data resource using the ordering on which the dependencies of the custom data resource are based, etc.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for providing desired computer implemented services using data stored in data sources of a distributed system, the method comprising:
obtaining a query that implicates a custom data resource of data resources, the custom data resource being based only on local portions of the data of the data resources;
obtaining an update process for the custom data resource;
performing the update process to update at least one value of the custom data resource to generate an updated value of the custom data resource, the update process defining an ordering for updating of the local portions of the data and remote portions of the data of the data resources upon which the local portions of the data are based, the ordering being based on dependencies between the custom data resource, the local portions of the data, and the remote portions of the data;
using the updated value to generate a response to the query; and
servicing the query using the response to facilitate provisioning of the desired computer implemented services.

2. The method of claim 1, wherein at least a sub-portion of the local portions of the data are copies of the remote portions of the data.

3. The method of claim 2, wherein the distributed system comprises a plurality of clusters, and each of the plurality of the clusters hosts a respective portion of the data sources.

4. The method of claim 3, wherein the custom data resource is hosted by one of the plurality of the clusters, and the remote portions of the data are hosted by other clusters of the plurality of the clusters that are not the one of the plurality of the clusters.

5. The method of claim 4, wherein the local portions of the data are hosted by the one of the plurality of the clusters.

6. The method of claim 1, wherein the query specifies at least one operation to be performed with respect to the custom data resource.

7. The method of claim 6, wherein the at least one operation is with respect to the updated value.

8. The method of claim 1, wherein the custom data resource is based on a user request for the custom data resource.

9. The method of claim 8, wherein the custom data resource is derived from the data, and the data being a system of record for an organization.

10. A non-transitory machine-readable medium having instructions stored therein, which when executed by a processor, cause the processor to perform operations for providing desired computer implemented services using data stored in data sources of a distributed system, the operations comprising:
obtaining a query that implicates a custom data resource of data resources, the custom data resource being based only on local portions of the data of the data resources;
obtaining an update process for the custom data resource;
performing the update process to update at least one value of the custom data resource to generate an updated value of the custom data resource, the update process defining an ordering for updating of the local portions of the data and remote portions of the data of the data resources upon which the local portions of the data are based, the ordering being based on dependencies between the custom data resource, the local portions of the data, and the remote portions of the data;
using the updated value to generate a response to the query; and
servicing the query using the response to facilitate provisioning of the desired computer implemented services.

11. The non-transitory machine-readable medium of claim 10, wherein at least a sub-portion of the local portions of the data are copies of the remote portions of the data.

12. The non-transitory machine-readable medium of claim 11, wherein the distributed system comprises a plurality of clusters, and each of the plurality of the clusters hosts a respective portion of the data sources.

13. The non-transitory machine-readable medium of claim 12, wherein the custom data resource is hosted by one of the plurality of the clusters, and the remote portions of the data are hosted by other clusters of the plurality of the clusters that are not the one of the plurality of the clusters.

14. The non-transitory machine-readable medium of claim 13, wherein the local portions of the data are hosted by the one of the plurality of the clusters.

15. The non-transitory machine-readable medium of claim 10, wherein the query specifies at least one operation to be performed with respect to the custom data resource.

16. A data processing system, comprising:
a processor; and
a memory coupled to the processor to store instructions, which when executed by the processor, cause the processor to perform operations providing desired computer implemented services using data stored in data sources of a distributed system, the operations comprising:
obtaining a query that implicates a custom data resource of data resources, the custom data resource being based only on local portions of the data of the data resources;
obtaining an update process for the custom data resource;
performing the update process to update at least one value of the custom data resource to generate an updated value of the custom data resource, the update process defining an ordering for updating of the local portions of the data and remote portions of the data of the data resources upon which the local portions of the data are based, the ordering being based on dependencies between the custom data resource, the local portions of the data, and the remote portions of the data;
using the updated value to generate a response to the query; and
servicing the query using the response to facilitate provisioning of the desired computer implemented services.

17. The data processing system of claim 16, wherein at least a sub-portion of the local portions of the data are copies of the remote portions of the data.

18. The data processing system of claim 17, wherein the distributed system comprises a plurality of clusters, and each of the plurality of the clusters hosts a respective portion of the data sources.

19. The data processing system of claim 18, wherein the custom data resource is hosted by one of the plurality of the clusters, and the remote portions of the data are hosted by other clusters of the plurality of the clusters that are not the one of the plurality of the clusters.

20. The data processing system of claim 19, wherein the local portions of the data are hosted by the one of the plurality of the clusters.
